(19) United States
(12) Patent Application Publication
(10) Pub. No.: US 2020/0238667 A1
(43) Pub. Date: Jul. 30, 2020

(54) USE OF UV-SENSITIVE INTERLAYER MATERIALS WITH NANO-STRUCTURED FUNCTIONAL COATING

(71) Applicant: CENTRAL GLASS COMPANY, LIMITED, Yamaguchi (JP)

(72) Inventors: Michael BARD, Primm Springs, TN (US); Hiromi HASE, Saitama (JP)

(73) Assignee: CENTRAL GLASS COMPANY, LIMITED, Yamaguchi (JP)

(21) Appl. No.: 16/755,083

(22) PCT Filed: Oct. 9, 2018
(86) PCT No.: PCT/US2018/054946

§ 371 Date: Apr. 9, 2020

Related U.S. Application Data
(60) Provisional application No. 62/570,477, filed on Oct. 10, 2017.

(51) Int. Cl. B32B 17/10

(52) U.S. Cl. CPC B32B 17/10678; B32B 17/10559; B60J 1/02; B32B 17/10045; B32B 17/10174; B32B 17/10504

(57) ABSTRACT

This disclosure relates generally to glass products having a UV protective coating. The coating is a porous, nano-structured coating having pores sized within the range of UV radiation. The porous structure may scatter UV light, protecting laminated interlayers and interior space protected by the glass products. The UV protective coating may be used in glass laminates having UV-sensitive interlayers, including switchable films where UV exposure may be limited.

### CROSS REFERENCE TO RELATED APPLICATION

This application claims priority to U.S. Provisional Patent Application No. 62/570,477 filed on Oct. 10, 2017, entitled “USE OF UV-SENSITIVE INTERLAYER MATERIALS WITH NANO-STRUCTURED FUNCTIONAL COATING,” the content of which is incorporated by reference herein in its entirety.

### TECHNICAL FIELDS

The present disclosure generally relates to coatings for transparent articles such as glass substrate. Among other things, the disclosed coatings have an improved UV-cut function with desired porous cores in nano-structured coatings.

### BACKGROUND

Ultraviolet (UV) light exposure is a concern to consumers wary of health concerns associated with exposure to UV light, including the threat of skin cancer. Thus, it is desirable to limit such exposure. UV light, however, may transmit through barriers between consumer and the solar radiation, including glass windows. In certain applications, including automotive and architectural, UV blocking or absorbing materials must be sufficiently durable to survive physical and chemical elements inherent to automotive and architectural use. UV absorbing additives are typically used within glass laminates to protect the polymer interlayers which may be damaged by UV radiation. However, there are not interior layers or additives available for tempered glass constructions that are not laminated. Therefore, it is desirable in the art to provide a UV-protective coating for use in automotive and architectural glass applications, which is durable enough to be applied to an outer glass surface. There is further a need for transparent UV-protective coatings for use with switchable film technologies and other UV-sensitive materials.

The following disclosure is based, in part, on certain coating technology published by Oak Ridge National Laboratory (ORNL) in the non-patent literature, Aytug, T. et al., Journal of Materials Chemistry C, Vol. 3, No. 21, pp. 5440-5449 (2015). This publication discloses a monolithic nano-structured coating comprising an interconnected network of nanoscale pores surrounded by a nanostructured silica framework, created through metastable spinodal phase separation. Among other things, the literature disclosed: “low-refractive index antireflective glass films that embody omni-directional optical properties over a wide range of wavelengths, while also possessing specific wetting capabilities.” The surface microstructures may have a graded reflective index, providing antireflective properties, suppressing surface reflection. The surface chemistry may be adjusted to provide self-cleaning qualities and provide resistance to mechanical wear and abrasion.

### SUMMARY OF DISCLOSURE

Disclosed herein are automotive or architectural glass products comprising a first glass substrate comprising a first side and a second side, a nano-structured coating on at least one of the first side and the second side of the first glass substrate, wherein the nano-structured coating is configured to have nano-pores ranging from 10 to 400 nm in diameter, wherein the nano-pores are not uniform in diameter to decrease UV diffuse transmittance.

In certain embodiments, the glass product has UV light transmittance of less than or equal to 50% or less than or equal to 25%.

In certain embodiments, the nano-pores may comprise first diameters from 10-100 nm, second diameters from 100-250 nm, and third diameters from 250-400 nm.

In further embodiments, the glass product may comprise a second glass substrate having a third side and a fourth side laminated to the first glass substrate, wherein the first and second glass substrates are substantially parallel and spaced apart from each other with at least one polymer interlayer therebetween. The at least one polymer interlayer may include polyvinyl butyral. Further, the at least one polymer interlayer may comprise UV absorbents to provide UV transmittance of at least 50%. In certain embodiments, the at least one polymer interlayer may include no UV absorbents.

In further embodiments, the glass product may include a switchable film between the first and second glass substrates. The switchable film may be a suspended particle device, polymer dispersed liquid crystal film, or polymer network liquid crystal.

In certain embodiments, the nano-structured coating may be on the first and second sides of the first glass product. In some embodiments, the nano-structured coating may be on at least one of the third and fourth sides of the second glass substrate or both the third and fourth sides.

The glass product may include a passivation layer between the nano-structured coating and the first and/or second glass substrates.

In further embodiments, the glass product may be laminated and may have a nano-structured coating on a glass surface within the laminate and comprise a protective layer between a nano-structured coating and the at least one polymer interlayer within the laminate.

Further disclosed herein is a method for manufacturing a glass product, the method comprising providing a first glass substrate having a first side and a second side, applying a coating to at least one of the first side and the second side of the first glass substrate, heating the coating and the first glass substrate to heat treat the first glass substrate and to cause phase separation in the coating, wherein heat treating the first glass substrate may comprise at least one of bending the first glass substrate or tempering the first glass substrate, and etching the coating to provide nano-pores that range from 10 to 400 nm in diameter.

In certain embodiments, heat treating the first glass substrate may comprise bending the first glass substrate.

In some embodiments, heat treating the first glass substrate may comprise tempering the first glass substrate, wherein phase separation of the coating occurs while the first glass substrate and the coating are heated and then the first glass substrate and coating are cooled to temper the first glass substrate.

The method may further comprise laminating the first glass substrate to a second glass substrate having a third side and a fourth side and providing at least one polymer interlayer between the first glass substrate and the second glass substrate. In further embodiments, the coating may be applied to at least one of the third side and the fourth side, the second glass substrate and the coating are heated to bend the second glass substrate and the coating and to cause phase separation in the coating. The coating may be etched to provide nano-structures and nano-pores that range from 10 to 400 nm in diameter prior to laminating the first and second glass substrates.

In certain embodiments, a switchable film may be provided between the first and second glass substrates. The switchable film may be a suspended particle deposition or polymer dispersed liquid crystal film.

In certain embodiments, the coating may be applied to the first side and the second side of the first glass substrate and/or the third and fourth side of the second glass substrate.

In certain embodiments, the coating may be applied by physical vapor deposition onto the first glass substrate, wherein the first glass substrate is flat. In further embodiments, the first glass substrate is soda-lime-silica glass. Further, the phase separation may be spinodal decomposition.

In certain embodiments, a nano-structured coating is used as a UV-protecting member in a glass window, wherein the coating is disposed on an exterior surface of the glass window. Further, the nano-structured coating may comprise nano-sized pores from 10 to 400 nm in diameter.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a typical construction of a laminated glass utilized in automotive, architectural and other applications;

FIG. 2 illustrates an improved UV-cut nano-structured coating is on either S1 or S2 to protect a polymer interlayer, so that the polymer interlayer such as UV sensitive PVB can reduce the amount of additive for UV absorption, according to an exemplary aspect of the present disclosure; and

FIG. 3 illustrates an improved UV-cut nano-structured coating is on either S1 or S2 or switchable functional interlayer to protect the switchable functional layer from the UV light, according to an exemplary aspect of the present disclosure.

### DETAILED DESCRIPTION

Disclosed herein are exemplary aspects of coatings that have an improved UV-cut function with desired porous cores in nano-structured coatings. In the following description, for purposes of explanation, specific details are set forth in order to promote a thorough understanding of one or more aspects of the disclosure. It may be evident in some or all instances, however, that any aspects described below can be practiced without adopting the specific design details described below.

Among other features, the present disclosure provides a coating for protection from ultraviolet (UV) light. Nano-structured coatings previously known are described as monolithic coatings, which may not be useful for optimizing functionality, such as protection from UV light. Functionality may be influenced by various processes, including concentrating and mixing glass types, heating at a duration and at temperatures in which phase separation occurs, and etching depth, based on acid or base etchant type and concentrations thereof, as well as the duration of etching.

As used herein, the term “S1” may refer to the exterior glass substrate surface in an automotive application. The term “S4” may refer to the interior glass substrate surface of a laminated automotive glass product. “S2” may be a glass substrate surface opposite S1 and “S3” may be a glass substrate surface opposite S4. In a laminated glass product, S2 and S3 may be a part of the laminate interior. S2 may be an interior glass substrate surface in automotive constructions using a single glass sheet, including a tempered glass sheet.

The development of the technology for utilization of a nano-structured coating may enhance one over the other properties, while only some of the key properties needed to support the following disclosure will be used, other properties may be enhanced.

Automotive windows may typically be made of laminated glass for windshields and tempered glass or sidelites (side windows) and backlites (back windows). Laminated glass may refer to a type of safety glass that may hold together when shattered. Laminated glass constructions may include interlayers sandwiched between glass substrates. The interlayers may include various materials, including polymer interlayers for binding the glass substrates into a laminated construct. For example, the polymer interlayer may include polyvinyl butyral (PVB), polyurethane (PU), ethylene-vinyl acetate (EVA), polyethylene terephthalate (PET) and any other suitable polymer interlayer. These materials may be produced having UV absorbing additives to provide protection from UV light. UV absorbers may include, without limitation, benzotriazole based materials, such as Tinuvin® P, Tinuvin® 320, Tinuvin® 326 and Tinuvin® 328 and combinations thereof, malonate compounds, or oxalate-anilide compounds. The polymer interlayers may be aged by the UV light and it may be beneficial to slow the aging process with UV absorbers. The UV absorbing additives may also protect the interior of a vehicle from UV exposure. Tempered glass substrates may not include a polymer interlayer and may not typically have UV absorbing function. Thus, there is a need for UV blocking coatings that may limit the need for UV absorbing additives and provide UV blocking solutions for non-laminated glass constructions in automotive and architectural applications that are prone to mechanical and chemical elements that may damage sensitive coatings.

A nano-structured coating 10 having pore sizes throughout the UV wavelengths (10 nm to 400 nm) may scatter and block UV light. Such a coating 10 may be applied to a glass surface to protect interlayer materials and an automotive or architectural interior environment. The nano-structured coating 10 may be applied to an exterior glass surface and may be provided as a UV-protecting member.

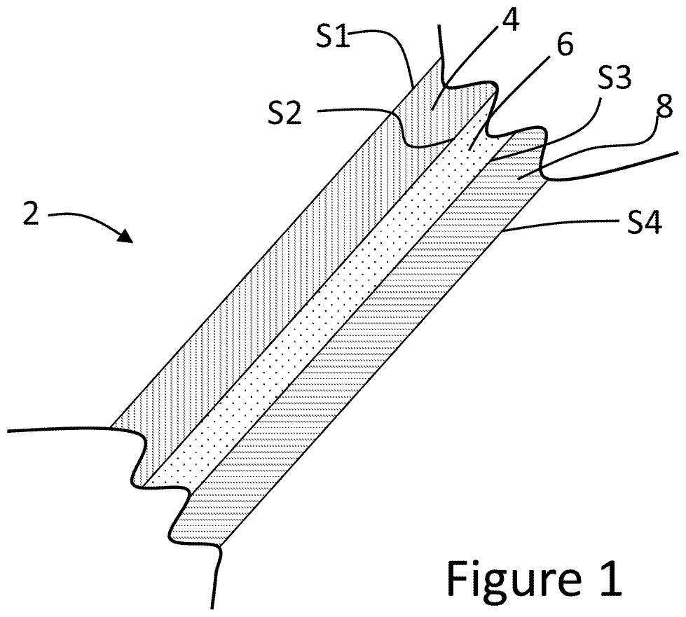

Referring to FIG. 1, a cross-sectional view of a conventional windshield 2 is provided. The windshield 2 may include a first glass substrate 4 and a second glass substrate 8 with a polymer interlayer 6 therebetween. The first glass substrate 4 and the second glass substrate 8 may be formed in a substantially parallel, spaced-apart relation to one another. The first glass substrate may include surfaces S1 and S2, where S1 may face the vehicle exterior. The second glass substrate 8 may face a vehicular interior and include surfaces S3 and S4. To prepare a windshield, glass substrates 4, 8 may be initially flat and heat treated to bend the glass substrates 4, 8, typically at temperatures of at least 500° C., and more preferably at least about 600° C. Glass sheets may be used outside of a laminate as well. For example, glass substrates may be heat treated to provide thermal tempering or heat strengthening for uses outside of a windshield 2. Glass bending may preferably occur at temperatures from 560° C. to 700° C., more preferably from 600° C. to 650° C.

A polymer interlayer 6 including PVB or any other suitable polymer-based laminating material, such as EVA or PET may be provided to laminate the glass substrates 4, 8. In a laminating process which typically involves autoclaving, the two glass substrates 4, 8 with the interlayer 6 therebetween may be heated to at least a selected laminating temperature and pressure, for example, 110° C. to 160° C. and 10 to 16 bar, to bond the glass substrates 4, 8 to one another and also form the vehicle windshield 2 or other laminated window products such as a sunroof or hack window. The first and second parallel, spaced apart glass substrates 4, 8 thus sandwich the polymer interlayer 6 which may be substantially uniform in thickness. A lamination process may be used in windshields 2. Many conventional windshields 2 may include interlayers composed of multilayer plastics, such as a tri-layer PVB interlayer with acoustic insulation properties.

It is known that solar radiation reaching the earth consists of 3% ultraviolet rays (UV) (wavelengths of 10-400 nm), 55% infrared radiation (IR) (700-2500 nm), and 42% visible light (400-700 nm). When solar radiation reaches glass, for example, automotive or architectural glass, the radiation may partially be reflected off the glass surface, partially absorbed by the glass, and partially transmit through the glass. Solar radiation that is absorbed may then be released from the glass in an exterior or interior direction. Total solar energy transmittance Tₜₛ is a measurement used to compare and understand solar performance of a glass glazing. Tₜₛ is the sum of all solar radiant heat energy entering through transmittance and the absorbed energy that is emitted to an interior environment. Tₜₛ may be calculated based on ISO 13837-2008 “Road vehicles—Method of the determination of solar transmittance.” UV exposure is a concern for the health and safety of consumers. UV exposure may lead to skin cancer, skin damage, and premature aging. Thus, there is a desire to limit UV exposure, even where there are no interlayer materials carrying UV absorbing additives.

The present disclosure provides a coating design having a durable nano-structured coating 10 suitable for UV blocking and scattering. The coating 10 may be applied to any glass surface in a construction, including S1, S2, S3, and S4. The nano-structured coating 10 may possess enhanced durability and optimal Tₜₛ performance (transparency).

In one aspect of the disclosure, the fabrication of the UV protective nano-structured coating 10 may include deposition of a precursor coating that may spinodally (i.e., non-nucleation, continuous phase separation) decompose when thermally processed. Particularly, the precursor coating may be a composition comprising SiO₂, B₂O₃, and Na₂O. The composition may be adjusted for particular applications by altering the composition of the glass, the duration and temperature during phase separation, and the etching depth. The coating material may be x % SiO₂, y % B₂O₃, and z % R₂O, wherein R may be an alkali metal element such as Li (lithium), Na (sodium) or K (potassium). In certain embodiments, the alkali metal may preferably be Na. The sum of x, y, and z may be at least 95, preferably at least 99, and more preferably at least 99.5. Preferably, x may range from 60 to 70, y may range from 20 to 30, and z may range from 5 to 12. More preferably, x may range from 64 to 68, y may range from 24 to 28, and z may range from 6 to 10. In an exemplary embodiment, the precursor composition may include 66% SiO₂, 26% B₂O₃, and 8% Na₂O and be deposited by magnetron sputter coating. Sputter coating may in the presence of Ar and O₂ in a ratio of 3:1. Film deposition may be completed by any suitable means. Particularly, the deposition may be carried out by physical vapor deposition (e.g. magnetron sputtering) or chemical vapor deposition.

The precursor coating may be deposited onto a transparent substrate, which may include soda-lime-silica glass substrates 4, 8 which may be defined by ISO 16293-1:2008, without limitation. Subsequent heat treatment may cause phase separation in the precursor coating to form interpenetrating patterns including, e.g., sodium-borate-rich and silica-rich phases. Sodium-borate is relatively more soluble than the silica by various chemicals. Heat treatment that causes phase separation may concurrently heat treat the underlying substrate 4, 8. The underlying substrate 4, 8 may include a glass sheet which may be tempered or bent in preparation for a particular application. The tempering or bending process may require the glass substrate 4, 8 to be heated, reaching temperatures of at least 500° C. and more preferably at least 600° C. Glass bending of soda-lime-silica glass may preferably occur at temperatures from 560° C. to 700° C., more preferably from 600° C. to 650° C. The glass substrate 4, 8 may preferably be held at such temperatures from 10 to 15 minutes. The coated substrate 4, 8 may be cooled after heat treatment.

Subsequently, a controlled level of differential etching may be employed to selectively dissolve the sodium-borate-rich phase, leaving behind a three-dimensional reticulated network of high-silica content glass phase, or a nano-structured coaling 10. The nano-structured coating 10 may have a high mechanical and chemical durability due, in part, to the durable nature of SiO₂ glass. Since the spinodal phase separation is a kinetically driven diffusion-controlled process, for a given glass composition, the structure and dimensions of the resultant phases and matrix microstructure may be controlled by the heat treatment temperature and duration, combined with certain etch conditions (i.e., etchant type, concentration, and etch duration). Nano-sized pores formed by etching may be preferably less than 400 nm, more preferably less than 100 nm.

The etchant may be chemical using any suitable etching chemical. The etching material may leave the silica-rich phase and remove the sodium-borate-rich phase. Suitable etching chemicals may include, without limitation, hydrogen chloride, hydrogen fluoride, hydrogen sulfate, and oxides, including buffered variations thereof.

In certain embodiments, it is preferable to optimize UV-scattering properties of the nano-structured coating 10. The nano-pores sized throughout the UV wavelength range may scatter UV rays before the UV radiation reaches interlayers or an interior environment. Thus, the nano-pores may preferably be in the range from 10-400 nm in size. For example, these nano-pores may comprise first diameters from 10-100 nm, second diameters from 100-250 nm, and third diameters from 250-400 nm. These pores may provide increased surfaces that may reflect the UV wavelengths. The nano-structured coating 10 may have a suitable thickness to provide nano-pores sized throughout the range of UV wavelengths. Preferably, the nano-structured coating 10 thickness may range from 50 nm to 1 μm, more preferably from 100 nm to 400 nm. In an exemplary embodiment, the precursor coating may be applied by sputter coating to provide a 400 nm coating which may remain 400 nm after etching. The etching process may not change the thickness of the coating 10 as the silica-rich phase through the coating 10 remains intact after etching.

The phase separation by heat treatment of the precursor coating may provide varying pore sizes. Further pore size differentiation may be formed by the etching process. For example, multiple etchants having varying strengths may be used to provide a variation in pore sizes. A strong etchant, hydrogen chloride, may be applied to the phase separated coating and removed before the entire coating may be etched. Then, a weaker etchant, which may be a buffered solution of the strong etchant, may be applied to the partially etched coating. A weaker etchant may be less reactive and leave smaller pores below a surface that was etched more fully with the strong etchant. The weaker etchant may be removed before complete etching, such that some sodium-borate-rich phase may remain in the nano-structured coating 10. A passivation layer, which may be SiO₂, TiO₂ or ZrO₂ without limitation, may be applied between the underlying substrate 4, 8 and the nano-structured coating 10 to protect the substrate 4, 8 from residual sodium-borate-rich phases. The passivation layer may be 5-300 nm thick. The process may be repeated with progressively weaker etchants to achieve gradually smaller pores closer to the underlying substrate 4, 8. Thus, the nano-structured coating 10 may have a porous structure wherein interconnected pores have a variety of sizes from 10 nm to 400 nm. The nano-structured coating 10 having varying pores sizes may reflect at least 45% of UV radiation, preferably at least 50%, and more preferably at least 60% of UV radiation. The reflectance may be determined by ISO 9050:2003. Particularly, a UV-Vis-NIR spectrophotometer with a deuterium or tungsten lamp may be used for determining reflectivity and/or transmittance. Total light transmittance, which includes diffuse transmittance, may be preferably measured using an integrating sphere.

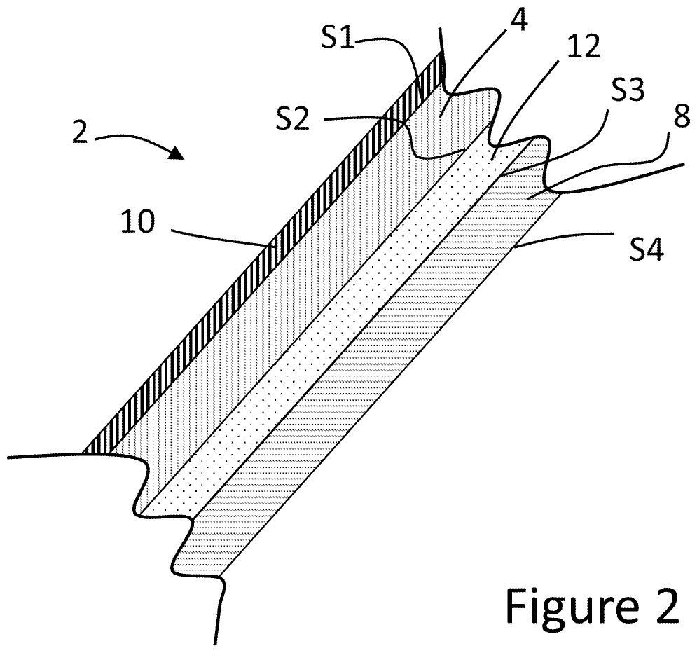

As shown in FIG. 2, the nano-structured coating 10 may be applied to an outer surface S1 of a glass product. The nano-structured coating may further be applied to additional surfaces of a glass product. For example, in a laminated windshield 2, the nano-structured coating may be applied to each side the first glass substrate 4 to better protect interlayer materials 12 and to the second glass substrate 8 to further protect an interior cabin from UV exposure. Where the nano-structured coating may scatter and block 60% of UV radiation and may be applied to S1 and S2, the interlayers may be protected from 84% of the UV radiation reaching the windshield 2. Without additives in the polymer interlayer 12 and the nano-structured coating on each of S1, S2, S3, and S4, UV radiation to the cabin may be reduced by 97%. Fewer UV absorbing additives may be needed in a polymer interlayer 12 where less UV radiation reaches the interlayer 12. For example, where the nano-structured coating 10 may provide a reduction of UV transmittance to the interlayer 12 by 60%, the interlayer 14 may include 50% less UV absorbents, preferably 60% less UV absorbents from a conventional interlayer. Thus, the interlayer 14 may provide 50% UV transmittance as determined outside of a glass construction having the nano-structured coating 10. A laminated glass construction may include a polymer interlayer 12 that does not include UV absorbing additives.

Sputter coating the coating precursor onto a glass substrate 4, 8 may form a strong bond between the nano-structured coating 10 precursor and the glass substrate 4, 8 when compared to wet coating processes. Further, the structures within the nano-structured coating may be less than 400 nm and remain transparent, even at coating thicknesses above 400 nm. Visible light transmission through the construct may be maintained even with a thick coating 10 durable enough for an outer glass surface. The thick nano-structured coating 10 may have a sponge-like structure of interconnected nano-structures and pores which may increase the nano-structured coating 10 durability and resistance to impact from hard and sharp objects, such as stones or sand. The sponge-like nano-structure may absorb energy from the impact, protecting the underlying substrate 4, 8. The interconnected structure may not easily break away from itself. Thus, the nano-structured coating 10 may remain intact over the substrate 4, 8, even through exposure to various physical or chemical elements. Further, the porous structure of the nano-structured coating 10 may remain intact through subsequent heating, including autoclaving typical for glass constructions.

A durable hydrophobic coating may further be applied to the nano-structured coating 10 to provide a surface having a water droplet contact angle greater than 150 degrees, which is suitable for S1 and S4 applications. Any suitable water repellent functional coating, including fluoroalkyl silane compounds, perfluoropolyether silane compounds, alkyl silane compounds, silazane compounds, and silicone compounds, may be used over a top coat of the laminated windshield 2. Methods of applying such coating may include dip coating, spin coating, spray coating, and nozzle flow coating followed by drying or firing processes. In one aspect, the etched coating described herein may provide a water droplet contact angle of 156 degrees. The water droplet contact angle may be measured using an optical tensiometer and a 5 μl water droplet on a coated glass substrate 4, 8. The coated surface may remain superhydrophobic (contact angle≥150 degrees) after abrasion treatment with aluminum oxide applied at a rate of 5 gram/minute for 2 minutes at 40 km/hr. For example, the contact angle of the disclosed coating 10 under such conditions may remain at 155 degrees. Preferably, the contact angle may remain above 150 degrees after 8 minutes of such treatment. Thus, the coating 10 may become durable and suitable for application to S1 or S4.

In one aspect of the disclosure, heat handling may accomplish glass heat treatment and phase separation at the same time. Glass heat treatment may include bending or tempering the glass 4, 8. For example, without limitation, a glass substrate 4, 8 having a nano-structured coating 10 precursor may be heat-treated at approximately 560-700° C. for about 10-20 minutes (e.g., glass bending or tempering condition) during which, the nano-structured coating 10 precursor may be phase separated. The bending process may be configured to hold the glass substrate 4, 8 at a selected peak temperature for, e.g., 10-15 minutes. It should be appreciated that the glass bending/tempering process may be configured based on various factors including: the specific thickness, color and/or chemical composition of the glass substrate 4, 8, where the bending process takes place (out-of-furnace or in-furnace), where the glass cooling process takes place, whether the final product is laminated glass or tempered glass, and the required transportation conditions. The etching depth may further control pore sizes and UV scattering properties as disclosed herein.

In accordance with aspects of the present disclosure, a nano-structured coating 10 precursor may be applied to a glass substrate 4, 8 when the glass substrate 4, 8 is flat. The structure, including the glass substrate 4, 8 and the nano-structured coating 10 precursor, may be then heated to provide phase separation in the nano-structured coating 10 precursor and to heat treat the glass substrate 4, 8. The heat treatment may include bending or tempering the glass substrate 4. 8. Where the glass substrate 4, 8 is tempered, the structure may be heated as described herein and then the structure, including the nano-structured coating 10 precursor, may be cooled to temper the glass substrate 4, 8. Where the glass substrate 4, 8 is bent, the nano-structured coating 10 precursor may also be bent on the glass substrate 4, 8. After heat treatment, the glass substrate 4, 8 and nano-structured coating 10 precursor may be cooled and the nano-structured coating precursor may be etched to provide the nano-structured coating 10. Phase separation of the nano-structured coating 10 precursor may be achieved during the heat treatment. The phase separation may or may not be complete during the heat treatment. The nano-structured coating 10 precursor, after heating, may include substantially two phases, including one that may be more sensitive to etching. Chemical etching may be administered to remove the more sensitive phase to leave a silica-rich nano-structured coating 10 having a porous structure. The etching process may be selectively administered by selection of the strength of the etching materials and duration of the etching to provide a change in pore size through the nano-structured coating 10. The etching chemical may be washed off of the nano-structured coating 10 when the desired etching is complete.

In some embodiments, UV protection may be provided to the nano-structured coating 10 on S2 and/or S3 within a laminated glass product. Polymer interlayers 12 may soften at autoclaving temperatures, wherein the polymer interlayer 12 may fill the porous structure of the nano-structured coating 10. Thus, a protective layer may be used to prevent filling the entire porous structure. The protective layer may be any suitable material, including SiO₂ or polymer materials such as PET. The protective layer may be positioned between the nano-structured coating 10 and polymer interlayers 12.

Additionally, it is common for automotive glazings to be tinted a green, blue or grey color to protect a driver or passengers in a vehicle from solar radiation (such as infra-red or UV radiation), to increase thermal comfort in the cabin, as well as adding a styling element to the vehicle. The disclosed nano-structured coating 10 may be used in colored glass constructions as well as clear glass constructions.

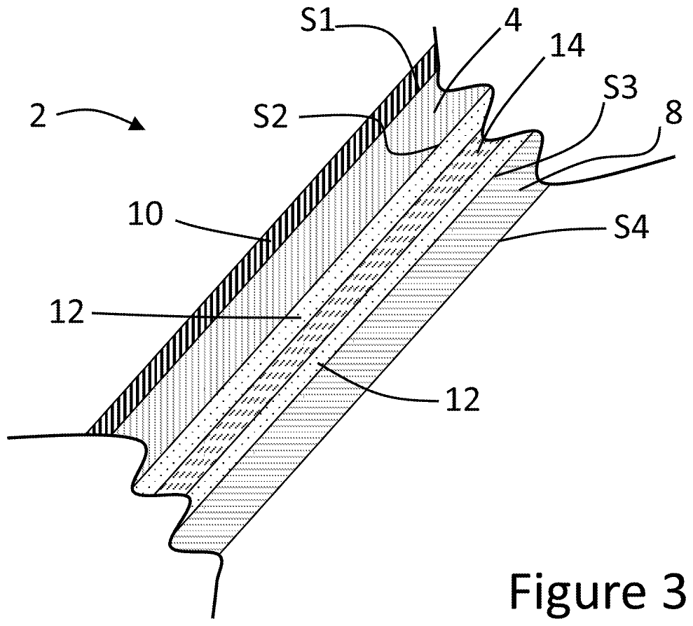

Other glass constructions may further include additional interlayer materials. For example, switchable films 14, as shown in FIG. 3, may be laminated between glass substrates for automotive and architectural uses. Switchable films 14 may include, but are not limited to, those based on liquid crystal constructions. A switchable film 14 may be selectively changed from an opaque or dark state to a transparent state by the application of an electric field to the film 14. For example, switchable films 14 may include polymer dispersed liquid crystal (PDLC), polymer network liquid crystal (PNLC), and suspended particle device (SPD) constructions. These films 14 may be sensitive to UV exposure which may age the switchable films 14. SPD films may be particularly sensitive to UV exposure. Thus. there is a need to protect the films 14 from UV light.

Referring to FIG. 2, a nano-structured coating 10 may be applied to either S1 or S2 of a first glass substrate 4 to prevent UV light from reaching the polymer interlayer 12. As the nano-structured coating 10 is reducing UV light transmittance, the polymer interlayer 12 may have a reduced amount of UV absorbing additives as compared to a conventional polymer interlayer 6. The coating 10 may further be used on both S1 and S2 to further protect against UV radiation. The nano-structured coating 10 may be configured to have a porous structure sized throughout the UV spectrum. Thus, UV wavelengths may be scattered and blocked throughout the entire range, providing improved reduction of UV light transmittance (e.g., less than or equal to 25% UV light transmittance).

The UV scattering nano-structured coating 10 may be used to protect any UV sensitive interlayers. Referring to FIG. 3, an improved UV scattering nano-structured coating may be applied on either S1 or S2 of a glass substrate or on switchable functional interlayer to protect the switchable functional layer from UV light. Switchable films 14 may be useful in a variety of constructions, including for providing optional privacy or as a display screen.

Switchable films 14, such as SPD, may be sensitive to UV exposure. UV radiation ages the film 14 and may affect the degree to which the film switches from an opaque phase to a clear phase. A SPD film may be embedded in a glass laminate. Glass substrates 4, 8 are laminated having polymer interlayers 12 surrounding the switchable film 14. The UV scattering nano-structured coating 10 may protect both the polymer interlayers 12 and the switchable film 14 from UV exposure.

In an exemplary embodiment, a glass composite of 66% SiO₂, 26% B₂O₃, and 8% Na₂O may be magnetron sputter coated onto a flat glass substrate 4 that is soda-lime-silica glass, in a layer having a 350 nm thickness. A SiO₂ layer may be applied on the glass substrate 4 prior to sputter coating the glass composite. The coated, flat glass substrate 4 may be then heated to 620 deg. C. The heating process may include gradually increasing and gradually decreasing temperature. The glass substrate 4 and coating may be heated to at least 400 deg. C. for 14.8 minutes, at least 500 deg. C. for 10.85 minutes, and at least 600 deg. C. for 6.7 minutes. The glass substrate 4 may reach a maximum temperature of 659.5 deg. C. The process may take place in a Cattin furnace and include bending the glass substrate 4 and coating. During the heating process, the coating phase may separate into silica-rich phases and sodium-borate-rich phases. Once the bent glass substrate 4 cools, the coating may be etched to remove the sodium-borate-rich phase from the coating.

Etching may be completed by applying a 10:1 buffered oxide etch, including hydrogen fluoride and ammonium fluoride with deionized water, and removing the etchant after wet application for 20 seconds. A 20:1 buffered oxide etch may then be applied to the coating and removed after 20 seconds. Finally, a 30:1 buffered oxide etch may be applied to the coating and removed after 20 seconds. The etched coating 10 may have a nano-structured surface, including pores sized under 400 nm. The soda-lime-silica glass may include pores from 10-400 nm in size.

Once the coating 10 is etched, a water repellent coating, 1H,1H,2H,2H-perfluorooctyltrichlorosilane hexane solution, may be applied to the nano-structured coating 10. A water droplet contact angle, measured using an optical tensiometer and a 5 μl water droplet on a coated glass substrate 4, may be measured at 156 degrees. After aluminum oxide is applied at 40 km/hr at 5 gram/minute for 8 minutes, the contact angle may become 155 degrees.

To prepare the inner glass surface 8 having a conductive coating 14, the conductive coating 14 may be sputter coated onto the glass substrate 8 prior to sputter coating a SiO₂ glass over the conductive coating 14. The glass composite may then he applied and treated as described herein for the outer glass substrate 4. The glass substrates 4, 8, having etched coatings 10, may be then laminated together with a PVB interlayer 12 having no UV absorbing additives. A switchable film 14 may further be included in the lamination.

In the case of a tempered glass product, the glass composite may be sputter coated onto a glass substrate which is then heated to heat treat the glass and to cause phase separation in the composite coating and cooled rapidly to cause tempering. The phase separated coatings on one or both sides of the tempered glass may then be etched as described herein. A SiO₂ passivation layer may further be sputter coated onto the glass substrate prior to the glass composite deposition.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An automotive or architectural glass product, comprising:
a first glass substrate comprising a first side and a second side;
a nano-structured coating on at least one of the first side and the second side of the first glass substrate,
wherein the nano-structured coating is configured to have nano-pores ranging from 10 to 400 nm in diameter,
wherein the nano-pores are not uniform in diameter to decrease ultraviolet (UV) diffuse transmittance, and
wherein the nano-pores comprise first diameters from 10-100 nm, second diameters from 100-250 nm, and third diameters from 250-400 nm.

2. (canceled)

3. The glass product according to claim 1, wherein the glass product has UV light transmittance of less than or equal to 25%.

4. (canceled)

5. The glass product according to claim 1, further comprising:
a second glass substrate having a third side and a fourth side laminated to the first glass substrate, wherein
the first and second glass substrates are spaced apart from each other with at least one polymer interlayer therebetween.

6-10. (canceled)

11. The glass product according to claim 1, wherein the nano-structured coating is applied on the first side and the second side of the first glass substrate, respectively.

12. The glass product according to claim 1, further comprising an undercoating comprising a passivation layer between the nano-structured coating and the first glass substrate.

13. The glass product according to claim 5, wherein the nano-structured coating is applied on at least one of the third side and the fourth side of the second glass substrate.

14-16. (canceled)

17. The glass product according to claim 13, further comprising a passivation coating between the nano-structured coating and the second glass substrate.

18. A method of manufacturing a glass product, comprising:
providing a first glass substrate having a first side and a second side;
applying a coating to at least one of the first side and the second side of the first glass substrate;
heating the coating and the first glass substrate to heat treat the first glass substrate and to cause phase separation in the coating, wherein heat treating the first glass substrate comprises at least one of bending the first glass substrate or tempering the first glass substrate; and
etching the coating to provide nano-pores that range from 10 to 400 nm in diameter,
wherein the nano-pores comprise first diameters from 10-100 nm, second diameters from 100-250 nm, and third diameters from 250-400 nm.

19. The method according to claim 18, wherein heat treating the first glass substrate comprises bending the first glass substrate.

20. The method according to claim 18, wherein heat treating the first glass substrate comprises tempering the first glass substrate, wherein phase separation of the coating occurs while the first glass substrate and the coating are heated and then the first glass substrate and coating are cooled to temper the first glass substrate.

21. The method according to claim 18, further comprising:
laminating the first glass substrate to a second glass substrate having a third side and a fourth side, and
providing at least one polymer interlayer between the first glass substrate and the second glass substrate.

22. The method according to claim 21, further comprising:
applying the coating to at least one of the third side and the fourth side of the second glass substrate;
heating the second glass substrate and the coating to bend the second glass substrate and the coating and to cause phase separation in the coating; and
etching the coating to provide nano-structures and nano-pores that range from 10 to 400 nm in diameter, prior to laminating the first glass substrate to the second glass substrate.

23. The method according to claim 21, further comprising:
providing a switchable film between the first glass substrate and the second glass substrate.

24. (canceled)

25. The method according to claim 18, wherein the coating is applied to the first side and the second side of the first glass substrate, respectively.

26. The method according to claim 22, wherein the coating is applied to the third side and the fourth side of the second glass substrate, respectively.

27. The method according to claim 18, wherein the coating is applied by physical vapor deposition onto the first glass substrate, wherein the first glass substrate is flat.

28-29. (canceled)

30. The glass product according to claim 1, wherein the nano-structured coating is used as a UV-protecting member for a glass window, wherein the nano-structured coating is disposed on an exterior surface of the glass window.

31. The method according to claim 18, wherein etching comprises:
partially etching the coating with a first etchant,
removing the first etchant,
further etching the coating with a second etchant, and
removing the second etchant, wherein the second etchant is weaker than the first etchant.

32. The method according to claim 18, further comprising:
forming a passivation layer on at least one of the first side and the second side of the first glass substrate,
wherein the passivation layer is between the coating and the first glass substrate.
